(19) United States
(12) Patent Application Publication
(10) Pub. No.: US 2008/0172992 A1
(43) Pub. Date: Jul. 24, 2008

(54) VACUUM CLEANER WITH OPENABLE LID

(75) Inventor: Wayne Ernest Conrad, Hampton (CA)

Correspondence Address: BERESKIN AND PARR, 40 KING STREET WEST, BOX 401, TORONTO, ON, M5H 3Y2, omitted

(73) Assignee: G.B.D. CORP., Nassau (BS)

(21) Appl. No.: 11/953,420

(22) Filed: Dec. 10, 2007

Related U.S. Application Data
(60) Provisional application No. 60/893,990, filed on Mar. 9, 2007.
(60) Provisional application No. 60/870,175, filed on Dec. 15, 2006.
(60) Provisional application No. 60/884,767, filed on Jan. 12, 2007.

(51) Int. Cl. B01D 50/00

(52) U.S. Cl. 55/323; 55/321; 55/337

(57) ABSTRACT

A surface cleaning apparatus comprises two or more side-by-side housings, which contain operating components of the surface cleaning apparatus, such as fluid cleaning members or one or more fluid cleaning members and the suction motor of the cleaning apparatus, to provide a cleaning apparatus having a reduced height.

### CROSS-REFERENCES TO RELATED APPLICATIONS

This application claims priority from U.S. Provisional Patent Applications 60/893,990 filed on Mar. 9, 2007; 60/870,175, filed on Dec. 15, 2006, and 60/884,767, filed on Jan. 12, 2007.

### FIELD OF THE INVENTION

This application relates to surface cleaning apparatus such as vacuum cleaners, wet/dry vacuum cleaners and carpet extractors and, preferably, surface cleaning apparatus, which utilize a cyclone. More specifically, the application relates to surface cleaning apparatus, which have an openable lid for accessing a fluid flow path.

### BACKGROUND OF THE INVENTION

Various types of surface cleaning apparatus are known in the art. Known vacuum cleaners include various components, such as cyclones, filters, motors, as well as other components. Typically, if a user wishes to access one of the components, for example for cleaning or repairing, the vacuum cleaner must be at least partially disassembled.

### SUMMARY OF THE INVENTION

In accordance with this invention, a surface cleaning apparatus has side-by-side or adjacent housings that include operating components (e.g., two or more of a suction motor, the fluid cleaning stage or stages), and possibly all of the operating components, of the surface cleaning head. The use of the side-by-side housings permits a design having a reduced with a larger footprint. Such designs may be useful for hand or strap carryable vacuum cleaners, wet/dry vacuum cleaners and the like, where a reduced height may be beneficial. However, such a design could also be used for an upright or stick vacuum cleaner since an openable top panel may be provided to access a flow passage from the top of one housing to the top of another housing, e.g., from the outlet of one cleaning stage to the inlet of another cleaning stage or the suction motor where a blockage may occur. Thus a user may access the passage, possibly without bending over to check for a blockage. At the same time, one or more filter elements may be visible and removably mounted for cleaning and replacement.

In one broad aspect, a surface cleaning apparatus is provided. The surface cleaning apparatus comprises at least first and second adjacent housings, each housing having an upper portion. At least one openable lid is provided on the upper portions. The lid has an inner surface. A fluid flow path extends from a dirty fluid inlet to a clean air outlet of the surface cleaning apparatus and includes a suction motor. An air flow passage from the first housing to the second housing forming part of the fluid flow path and defined as a volume between the inner surface of the lid and the upper portions of the first and second housings. When the lid is opened, the airflow passage is accessible.

Embodiments in accordance with this broad aspect may be advantageous because a user may access the airflow passage to clean out a portion of the airflow passage. Alternately, or in addition, the user may clean out and/or repair one or more components adjacent the airflow passage, such as a filter.

In some embodiments, a single lid closes the upper portions. In further embodiments, the lid is pivotally mounted.

In some embodiments the first housing includes a cyclone chamber and the second housing includes the suction motor. In further embodiments, the first housing has a dirt collection chamber having a bottom and a plate is provided in a flow passage from the cyclone chamber to the dirt collection chamber and the bottom of the dirt collection chamber is pivotally mounted. In further embodiments, the plate is mounted to the bottom.

In some embodiments, the first housing comprises a single cyclone.

In some embodiments, the first and second housings have a volume and the surface cleaning apparatus has at least one cyclone and the at least one cyclone has a volume that is a least 40% of the volume of the first and second housings. In further embodiments, the at least one cyclone has a volume that is a least 60% of the volume of the first and second housings.

In some embodiments, the surface cleaning apparatus has at least one cyclone having a cyclone chamber and a cyclone chamber outlet and air travels from the cyclone chamber to the cyclone chamber outlet without passing through a porous member.

In some embodiments the second housing includes at least one removably mounted filter that is accessible when the lid is opened. In further embodiments, the at least one filter is provided in a filter housing and the filter housing is removably provided in the second housing and has handles.

In another broad aspect, a surface cleaning apparatus is provided. The surface cleaning apparatus comprises a fluid flow path extending from a dirty fluid inlet to a clean air outlet of the surface cleaning apparatus and including a suction motor. The surface cleaning apparatus further comprises at least first and second adjacent housings. Each housing has an upper portion. The first housing includes a cyclone and the second housing includes the suction motor. At least one top panel is provided on the upper portions, the top panel having an inner surface. An airflow passage extends from the first housing to the second housing and forms part of the fluid flow path. The airflow passage is defined as a volume between the inner surface of the top panel and the upper portions of the first and second housings.

In some embodiments, a single top panel closes the upper portions.

In some embodiments the top panel comprises an openable lid.

In some embodiments the first housing comprises a single cyclone.

In some embodiments the first and second housings have a volume, the surface cleaning apparatus has at least one cyclone and the at least one cyclone has a volume that is a least 40% of the volume of the first and second housings. In a further embodiment, the at least one cyclone has a volume that is a least 60% of the volume of the first and second housings.

In some embodiments, the cyclone has a cyclone chamber and a cyclone chamber outlet and air travels from the cyclone chamber to the cyclone chamber outlet without passing through a porous member.

In some embodiments the second housing includes at least one filter that is visible when the lid is opened. In further embodiments, the at least one filter is mounted in a filter housing and the filter housing has handles. In yet further embodiments, the at least one filter is positioned above the suction motor.

In another broad aspect, a surface cleaning apparatus is provided. The surface cleaning apparatus comprises a fluid flow path extending from a dirty fluid inlet to a clean air outlet of the surface cleaning apparatus and including a suction motor. The surface cleaning apparatus further comprises at least first and second adjacent housings. Each housing has an upper portion. The first housing has at least one cyclone having a cyclone chamber and a cyclone chamber outlet. Air travels from the cyclone chamber to the cyclone chamber outlet without passing through a porous member. At least one top panel is provided on the upper portions, the top panel has an inner surface. An airflow passage extends from the first housing to the second housing forming part of the fluid flow path and defined as a volume between the inner surface of the top panel and the upper portions of the first and second housings.

In some embodiments a single top panel closes the upper portions.

In some embodiments the top panel is openable.

In some embodiments the second housing includes the suction motor.

In some embodiments the first housing comprises a single cyclone.

In some embodiments the surface cleaning apparatus further comprises at least one filter that is visible when the top panel is opened.

In some embodiments a suction motor and fan assembly is positioned below the at least one filter.

In another broad aspect a surface cleaning apparatus is provided. The surface cleaning apparatus comprises a fluid flow path extending from a dirty fluid inlet to a clean air outlet of the surface cleaning apparatus and including a suction motor. The surface cleaning apparatus further comprises at least first and second adjacent housings. Each housing has an upper portion. An airflow passage extends from the first housing to the second housing, and forms part of the fluid flow path. The airflow passage is defined as a volume between the inner surface of the lid and the upper portions of the first and second housings. At least one filter is visible when the top panel is opened.

In some embodiments, the at least one filter is removably mounted in the surface cleaning apparatus

In some embodiments, the at least one filter is mounted in a filter housing and the filter housing has handles.

In some embodiments a single lid closes the upper portions.

In some embodiments, the first housing includes a cyclone and the second housing includes the suction motor.

### BRIEF DESCRIPTION OF THE DRAWINGS

These and other advantages of the present invention will be more fully and particularly understood in connection with the following description of the preferred embodiments of the invention in which:

FIG. 1A is a perspective illustration of an embodiment of a surface cleaning apparatus of the present invention, showing a lid in a closed position;

FIG. 1B is a perspective illustration of the embodiment of FIG. 1A, showing a lid in an open position;

FIG. 2 is a perspective illustration of an alternate embodiment of a surface cleaning apparatus of the present invention;

FIG. 3 is a perspective illustration of a further alternate embodiment of a surface cleaning apparatus of the present invention;

FIG. 4A is a cross section taken along line 4-4 in FIG. 1.

FIG. 4B is a cross section taken along line 4-4 in FIG. 1, showing a dirt chamber in an open position and showing a screen;

FIG. 4 C is a perspective illustration of the embodiment of FIG. 1B, showing a screen and a filter assembly removed from the surface cleaning apparatus;

FIG. 5 is a cross section taken along line 5-5 in FIG. 2;

FIG. 6-6 is a cross section taken along line 6-6 in FIG. 3;

FIG. 7 is a top view of the embodiment of FIG. 1;

FIG. 8 is a perspective view of an alternate embodiment of a surface cleaning apparatus of the present invention, showing a lid in an opened position;

FIG. 9 is an exploded view of the embodiment of FIG. 8;

FIG. 10 is a perspective view of an alternate embodiment of a surface cleaning apparatus of the present invention;

FIG. 11 is a side view of the embodiment of FIG. 10; and,

FIG. 12 is a cross section taken along line 12-12 in FIG. 10.

### DETAILED DESCRIPTION OF THE INVENTION

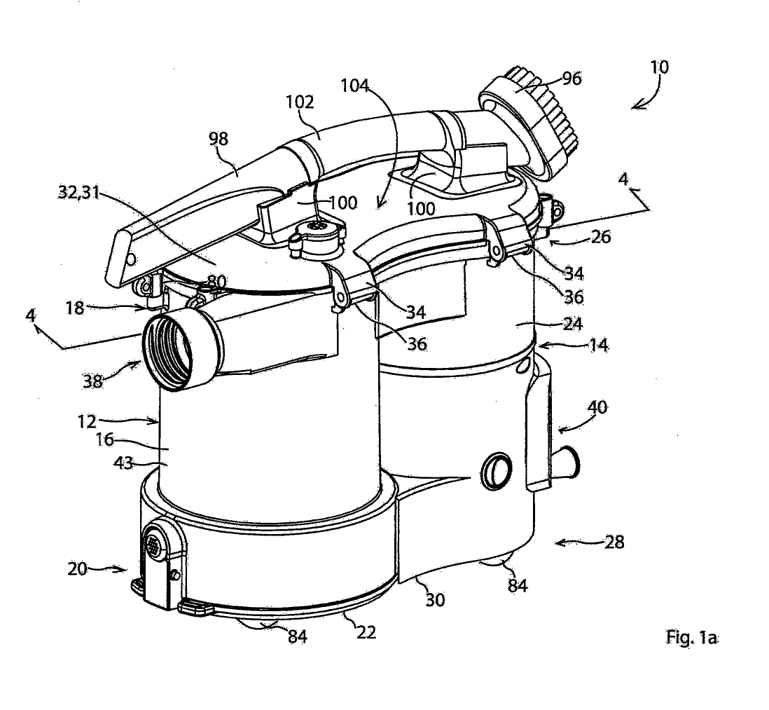

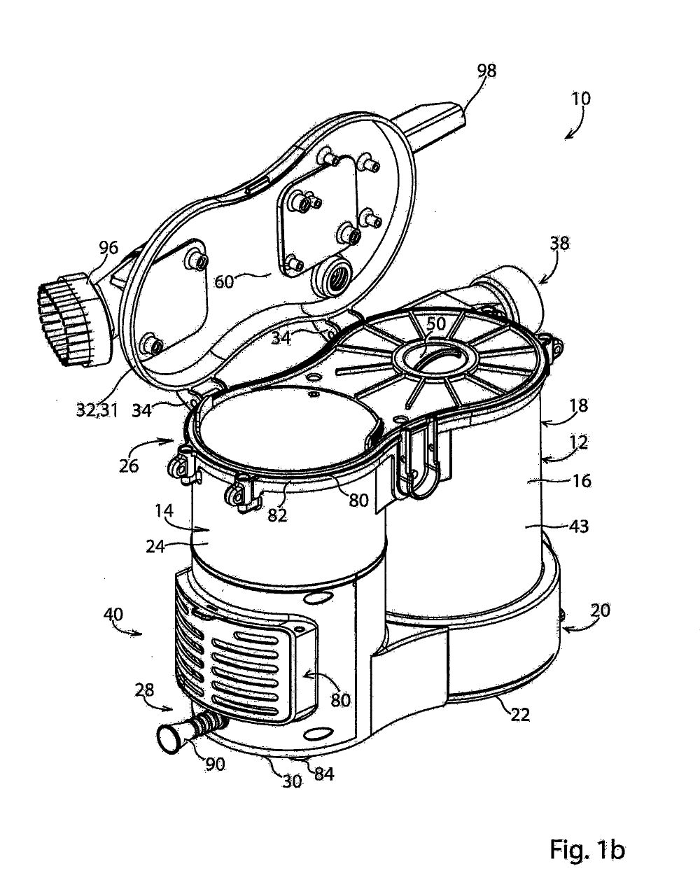

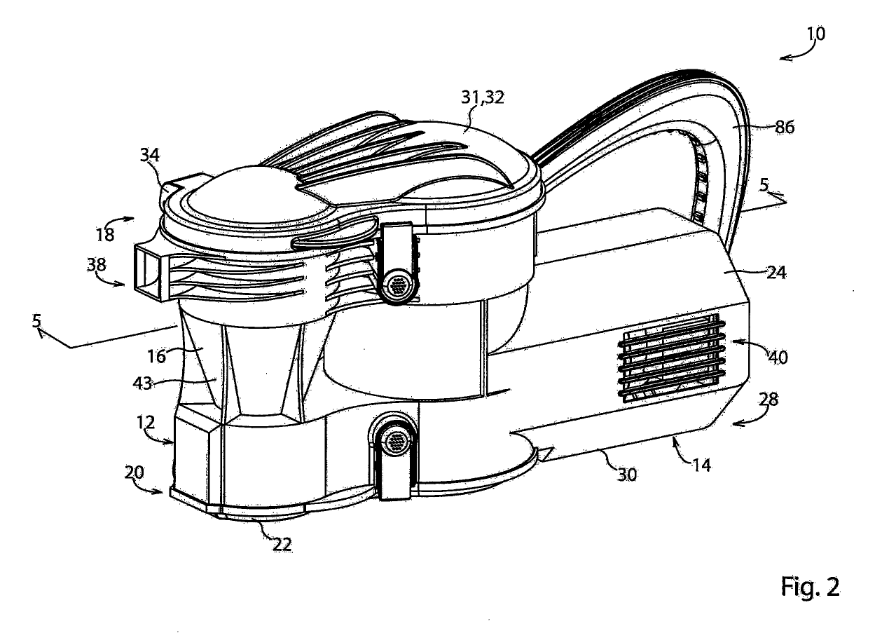

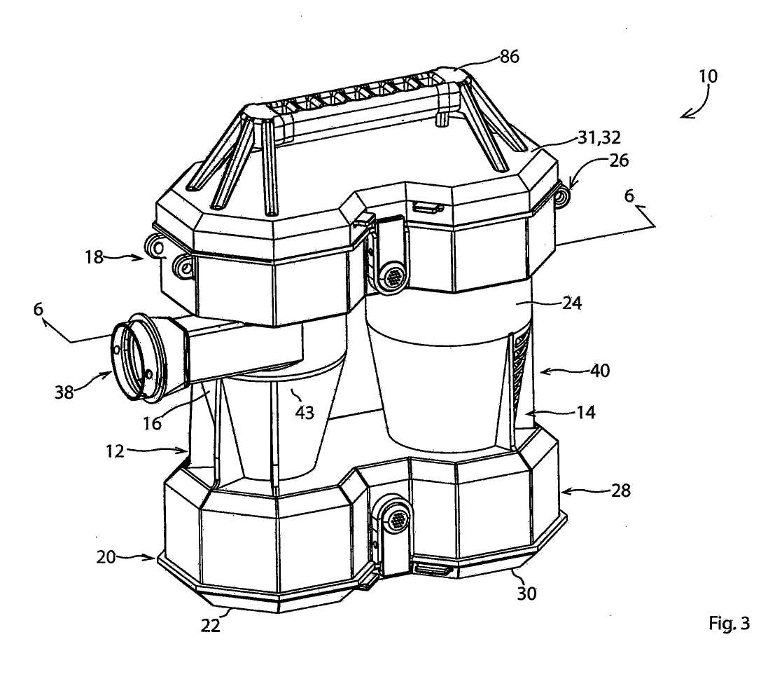

Embodiments of a surface cleaning apparatus 10 of the present invention are shown in FIGS. 1A, 1B, 2 and 3. As shown in FIGS. 1A and 1B, the surface cleaning apparatus 10 may be a wheel mounted vacuum cleaner, such as the type typically sold under the Shop Vac trademark. As shown in FIGS. 2 and 3, the surface cleaning apparatus 10 may be a hand or strap carryable vacuum cleaner. In other embodiments, the surface cleaning apparatus 10 may be another type of surface cleaning apparatus for example an upright vacuum cleaner, a canister type vacuum cleaner, a stick vacuum cleaner, a back pack vacuum cleaner, a carpet extractor or the like.

Surface cleaning apparatus 10 comprises a first housing 12 and a second housing 14, which are adjacent each other. First 12 and second 14 housings may be secured together as a single unit. For example, each of first and second housings 12, 14 may be separately manufactured and then secured together, such as by a common base or by gluing, welding or mechanically securing the two housings together. Alternatively, first housing 12 and second housing 14 may be integrally molded as a single unit.

As exemplified in FIG. 1A, first housing 12 comprises at least one side wall 16 extending between an upper portion 18 and a lower portion 20, and a bottom wall 22 at the lower portion. Second housing 14 comprises at least one side wall 24 extending between an upper portion 26 and a lower portion 28, and a bottom wall 30 at the lower portion 20. A top panel 31 is provided on the upper portions 18, 24. In some embodiments, preferably all or part of top panel 31 is a lid 32, which is openable.

Lid 32 is configured such that when a user opens lid 32, as exemplified in FIG. 1B, the user has access to the upper portions 18, 24 of each of housings 12 and 14. It will be appreciated that only a portion of top panel 31 may open. Further, it will be appreciated that top panel may have two or more parts that open, and, optionally, when all are open, all of top panel 31 is open. Preferably, as exemplified, top panel 31 is openable and/or removably mounted to surface cleaning apparatus 10.

In some embodiments, as shown in FIG. 1, lid 32 is provided with a plurality of flanges 34 which are mounted on flanges 36 provided on housings 12 and/or 14. Flanges 34, 36 may be pivotally connected together by pivot pins. Accordingly, lid 20 may be pivoted from the closed position, as shown in FIGS. 1, 2, and 3, to the opened position, as shown in FIG. 1B. In other embodiments, lid 32 may be openable in another manner in order to provide access to upper portions 18 and 24. For example, lid 32 may be removable from casings 12 and 14, i.e., it may merely lift off once a latch or lock or snap fit is released. Alternatively, lid 20 may be movably mounted by other means, for example, it may be mounted on a vertical pivot pin so that it rotates in a horizontal plane to permit access to the top of housings 12, 14.

In the embodiments shown, lid 32 is a single lid, which opens housings 12 and 14. In other embodiments, lid 32 may comprise separate lids for each housing (i.e. top panel 31 may comprise more than one panel).

Surface cleaning apparatus 10 comprises a fluid flow path extending from a dirty fluid inlet 38 to a clean air outlet 40. A suction motor 42 is provided in the fluid flow path. Various cleaning elements may be provided in the fluid flow path, as will presently be described.

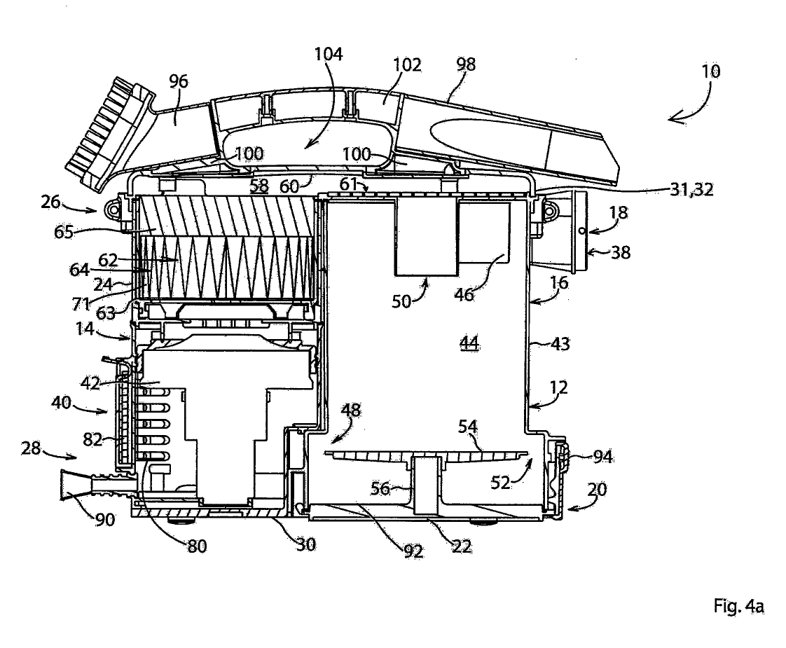

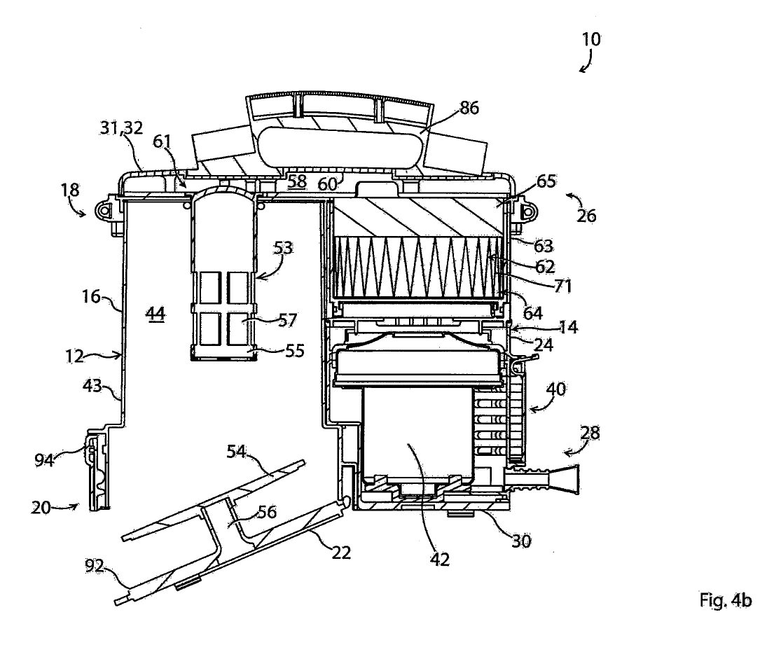

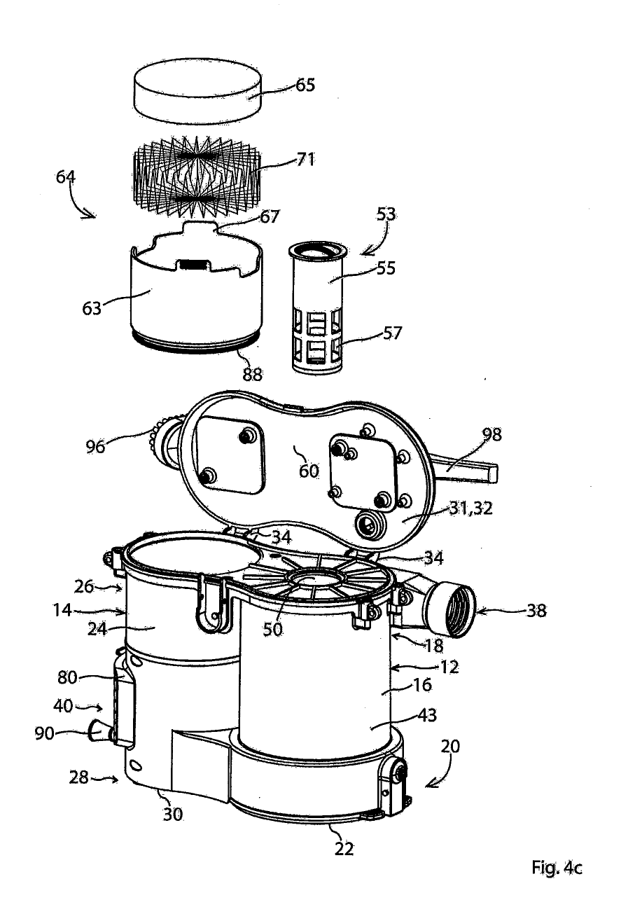

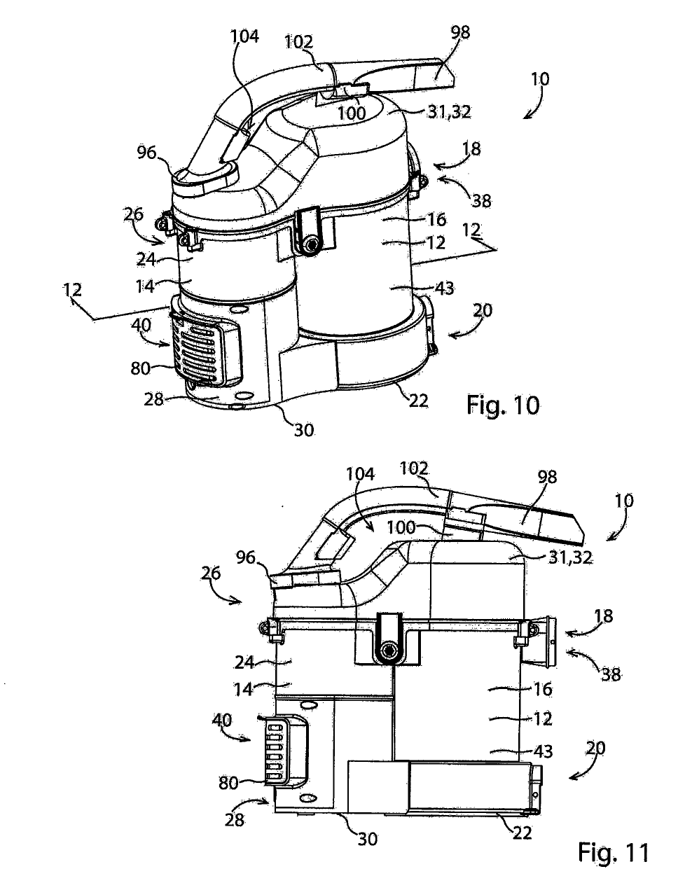

Referring to FIGS. 4-6, and 10-12, in the exemplified embodiments, a cyclone chamber 43 comprising a cyclone 44 is provided in first housing 12. Air enters cyclone chamber 43 from dirty fluid inlet 38. Dirty fluid inlet 38 may be in airflow communication with a ground engaging head or cleaning tool by, for example, a flexible hose, as is known in the vacuum cleaner art. Dirty fluid inlet 38 is preferably configured to create a cyclonic flow of air in cyclone chamber 43. Cyclone chamber 43 comprises a cyclone inlet 46, a dirt outlet 48, and an air outlet 50. A dirt collection chamber 51 is mounted below the cyclone 44 and includes an inlet or flow passage 52 in fluid communication with separated material outlet 48. Dirt collection chamber 51 may be integrally formed with one or both of first housing 12 and second housing 14. It will be appreciated that each of cyclone chamber 23 and dirt collection chamber 51 may be configured as any such chamber known in the art and may be positioned at any location known in the art. For example, as exemplified, dirt collection chamber 51 may comprise or utilize a plate 54 provided in flow passage 52 from the cyclone chamber 43 to the dirt chamber 51. Plate 54 may be mounted to bottom wall 22 by a pedestal 56, or may be mounted to another part of housing 12. Further, dirt collection chamber may be positioned in the bottom of cyclone chamber 23 as opposed to in a separate chamber separated by a dirt outlet from the cyclone chamber 23, with or without a divider plate 54.

Dirt collection chamber 51 may be emptied in a variety of ways, for example by pivoting a bottom portion thereof to an open position, as shown in FIG. 4B, or by being removable from surface cleaning apparatus 10. As exemplified in FIG. 4B bottom 92 of chamber 51 may be hinged to second housing 14 such that bottom 92, and, preferably plate 54, both pivot to a generally vertical position so as to permit dirt to fall out of chamber 51 into, e.g., a trash receptacle. Bottom 92 may then be secured in the closed position shown in by any means known in the art. For example, a push button 94 may be provided for releasing a catch to permit bottom 92 to pivot open.

Dirt collection chamber 51 may be emptied by any means known in the art. For example, it may be removably mounted to cyclone chamber 23, it may have a portion that is openable or it may be removed for surface cleaning apparatus with cyclone chamber 23.

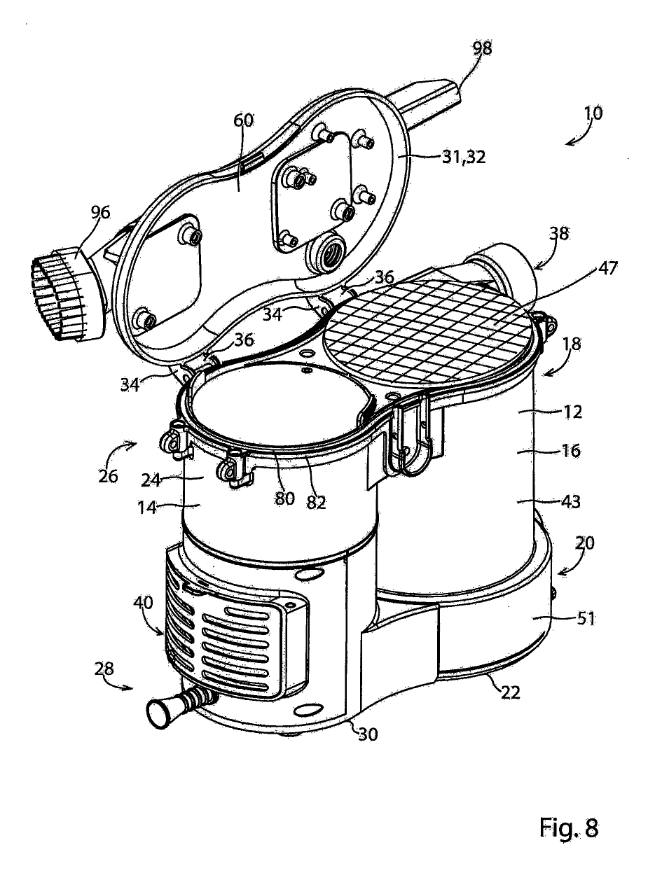

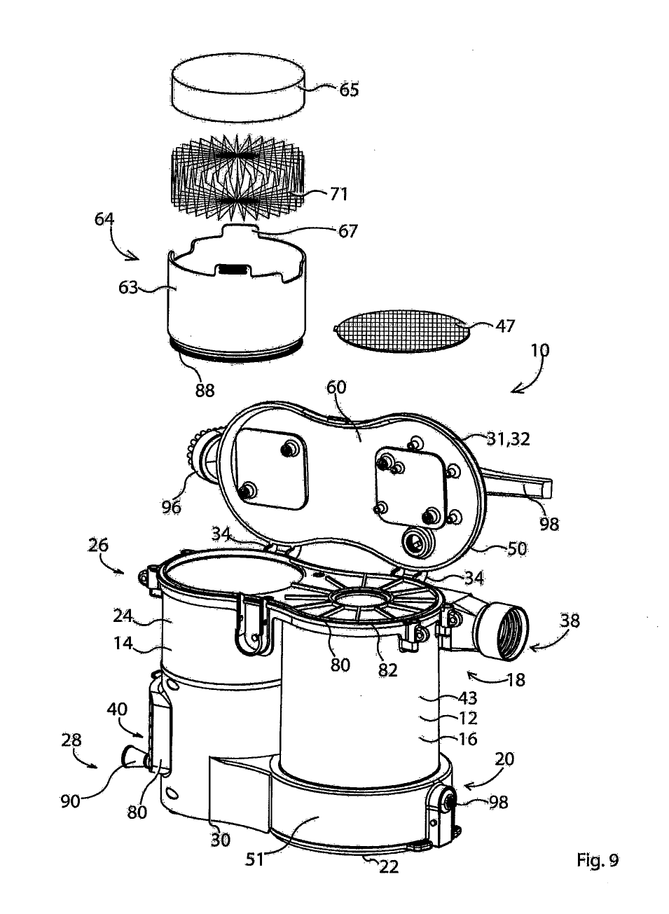

In some embodiments, cyclone 44 may further comprise a porous member such as a filter or a screen associated with outlet 50. For example, as shown in FIGS. 8 and 9, a screen 47 may be positioned on top of cyclone chamber 43 a the exit of cyclone outlet 50. Alternately, as shown in FIG. 4B, a cylindrical housing 55 may be mounted on outlet 50 and may have a plurality of openings 57 which may be provided with a screen (e.g. a wire mesh). Cylindrical housing 55 may be slidably mounted in outlet 50 such that when lid 32 is open, cylindrical housing 55 may be pulled upwardly for removal and cleaning, as shown in FIG. 4C. In other embodiments, air may travel from cyclone chamber 43 to the air outlet 50 without passing through a porous member.

The volume of each of the first 12 and second 14 housings may vary depending on the particular embodiment. However, in some embodiments, the volume of the cyclone 44 is at least 40% of the volume of the first 12 and second 14 housings. More preferably, in some embodiments, the volume of the cyclone 44 is at least 60% of the volume of the first 12 and second 14 housings.

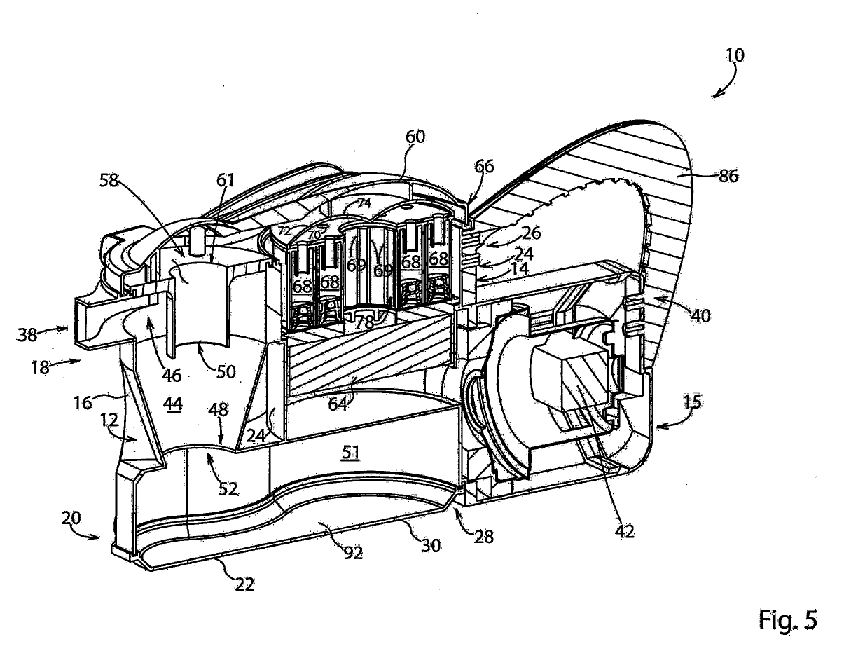

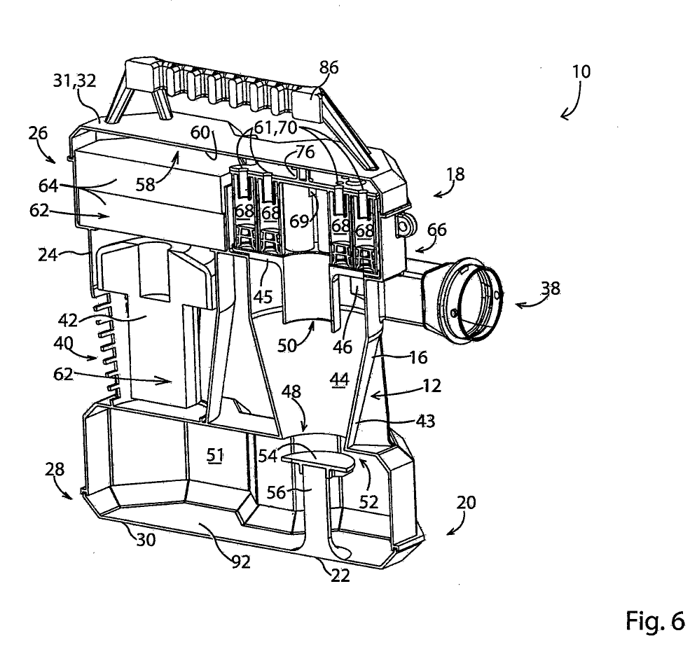

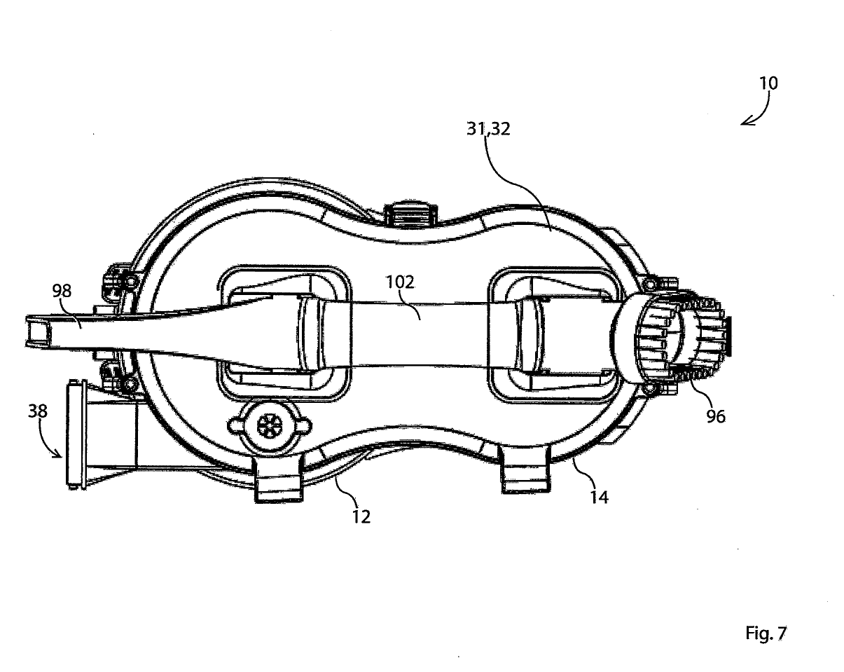

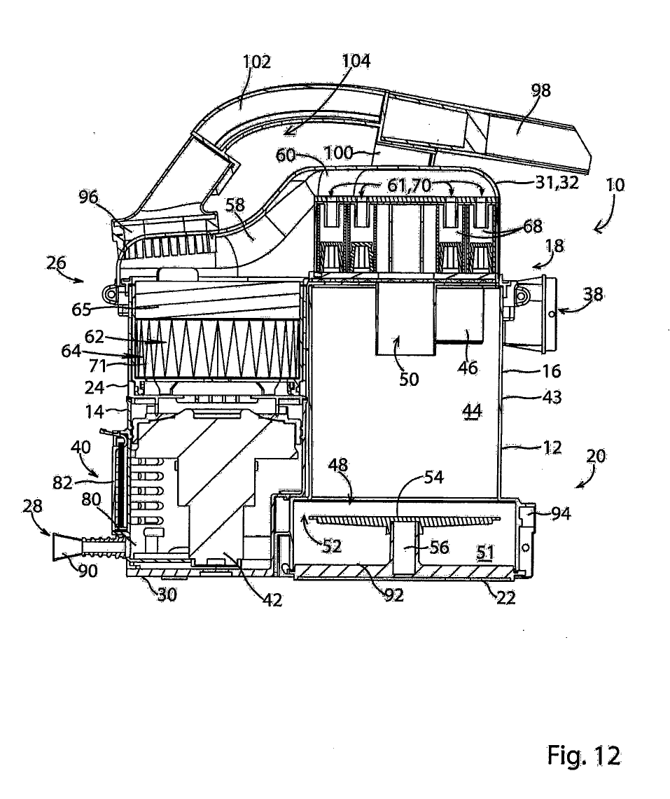

In the embodiments of FIGS. 4 and 5, cyclone 44 is housed in housing 12 alone, without any other cleaning elements. In the embodiment of FIGS. 6 and 12, housing 12 further houses a second cleaning stage 66 positioned above cyclone 44. Second cleaning stage 44 preferably comprises a plurality of second cyclones 68 as exemplified. Second cyclones 68 comprise air inlets 69 which are in fluid communication with air outlet 50 of cyclone 44, and air outlets 70. It will be appreciated that first housing may incorporate one or more additional cleaning stages upstream of downstream of cyclone chamber 23 and that the cyclone chamber 23 may be replaced by a plurality of cyclones as opposed to being a single cyclone.

The components of first housing 12 are in fluid communication with on one or more components (e.g. a cleaning stage or stages and/or a suction motor) 62 housed in housing 14 via an air flow passage 58 provided between the first housing 12 and the second housing 14. Airflow passage 58 is defined as a volume between an inner surface 60 of lid 32, and the upper portions 18, 26 of housings 12, 14. Accordingly, when a user opens lid 32, airflow passage 58 is accessible and can be cleaned out for example. In the embodiment of FIGS. 4 and 5, the inlet 61 to airflow passage 58 comprises air outlet 50 of cyclone 44. In the embodiment of FIG. 6, the inlet 61 to airflow passage 58 comprises air outlet 70 of second cyclones 68.

Referring to FIGS. 4A-C and 6, operating components 62 may comprise a filter assembly 64 and a motor and fan assembly 42, which is preferably positioned below filter assembly 64. Accordingly, in this embodiment, air enters cyclone 44 via cyclone inlet 46, exits cyclone 44 via air outlet 50, passes through airflow passage 58 and into filter assembly 64, and is directed past motor 42 and out of clean air outlet 40.

In some embodiments, filter assembly 64 may be removably received in housing 14. For example, referring to FIG. 4C, filter assembly 64 may comprise a filter housing 63, housing two or more filter elements, such as a foam filter 65 and a screen filter 71 or a foam filter and a pre-motor HEPA filter. When lid 32 is opened, casing 63 may be removed from housing 14, and one or more of filters 65 and 71 may be removed from casing 63, and may be replaced or cleaned, for example. In some embodiments, filter housing 63 may further include handles such as tabs 67, for gripping filter housing 63 to remove filter assembly from housing 14. Alternatively, rather than removing filter assembly 64 from housing 14, a user may simply open lid 32, and view filters 65 and/or 71, in order to determine if filters 65 and/or 71 are due to be replaced. The user may replace the filter or filters without removing a filter housing. Filter assembly may be mounted in second housing 14 by any means known in the art. For example, filter housing 63 may comprise a thread 88, which is receivable in a mating thread provided in second housing 14

Referring to FIG. 5, components 62 may comprise a second cleaning stage 66, and a filter assembly 64. In this embodiment, motor and fan assembly 42 are further housed in a third housing 15. The second cleaning stage 66 comprises a plurality of second cyclones 68 in parallel. Each of the second cyclones 68 in the assembly receives air from the air outlet 50 of the first cyclone 44, and discharges air through outlets 70 into a manifold 72. Manifold 72 is adjacent airflow passage 58, and is separated therefrom by a wall 74. Air is evacuated from the manifold 72 through a conduit 78 disposed centrally of the assembly. From the conduit 78 the air is drawn through filter assembly 64, towards the motor 42, and expelled from the apparatus 10 through the exhaust clean air outlet 40. In some embodiments, clean air outlet 40 may be provided with a grill 80. If a post motor filter is desired, then grill 80 may be openable or removable to reveal a filter 82, which may be positioned between second housing 14 and grill 80. Preferably, filter 82 is removable for cleaning or replacement.

In the embodiment shown, preferably the plurality of second stage cyclones 68 is removable as a unit, e.g., as a cyclonic array. The cyclonic array may be then opened and emptied. Alternately, part or all of the second stage cyclones may be separately removable.

In other embodiments, housings 12 and 14 may comprise other components or combinations of components. For example, housing 14 may comprise only motor 42. Alternatively, one of first housing and second housing 14 may comprise a third cleaning stage.

In order to prevent air leaking into passage 58 from exterior to the vacuum cleaner, a deformable seal, such as resilient bead 80 may be provided. For example, a shown in FIG. 2, each of first and second housings 12, 14 have a continuous top surface 82 on which resilient bead 80 is provided. When lid 32 is closed and locked into position, if the lock compresses bead 80, then an air tight seal will be provided such that air will not leak into plenum passage 58. Resilient bead 80 may be made out of any compressible material known in the vacuum cleaner art. For example resilient bead 80 may be manufactured from material that is similar to material used to manufacture O-rings. The lock may be a lever or any other device that will draw the lid down on the housings 12, 14 as the lock is moved into the locked position.

In any of the above embodiments, surface cleaning apparatus may be provided with one or more of wheels 84, straps, handles 86, or other members for aiding a user in maneuvering surface cleaning apparatus 10. In some particular embodiments, surface cleaning apparatus 10 may be provided with a shoulder strap (not shown), which may be secured to apparatus 10 by any attachment means known in, for example, the handbag or backpack arts.

An electrical cord may be connected to vacuum cleaner 10 at any appropriate location. An electrical cord (not shown) passes through cord mount 90, which is positioned at the bottom of second housing 14 adjacent motor 42.

In some embodiments, one or more accessories, such as cleaning brush 96 and wand extension 98 may be secured to the upper surface of lid 32, such as by means of mounts 100. Central section 102 may be configured to function as a handle (e.g. central section 102 may be arcuate in shape or be spaced from lid 32), to define an opening 104 between central section 102 and the upper surface of lid 32 such that central section 102 of brush 96 may be a carry handle for the vacuum cleaner.

It will be appreciated that any of the optional embodiments described herein may be used singularly in a vacuum cleaner or may be combined with one or more of the other preferred features to create a series of different vacuum cleaners, each of which is the subject of this disclosure.

1. A surface cleaning apparatus comprising:
(a) at least first and second adjacent housings, each housing having an upper portion;
(b) at least one openable lid provided on the upper portions, the lid having an inner surface;
(c) a fluid flow path extending from a dirty fluid inlet to a clean air outlet of the surface cleaning apparatus and including a suction motor; and,
(d) an air flow passage from the first housing to the second housing forming part of the fluid flow path and defined as a volume between the inner surface of the lid and the upper portions of the first and second housings,
whereby, when the lid is opened, the airflow passage is accessible.

2. The surface cleaning apparatus as claimed in claim 1 wherein a single lid closes the upper portions.

3. The surface cleaning apparatus as claimed in claim 2 wherein the lid is pivotally mounted.

4. The surface cleaning apparatus as claimed in claim 1 wherein the first housing includes a cyclone chamber and the second housing includes the suction motor.

5. The surface cleaning apparatus as claimed in claim 4 wherein the first housing has a dirt collection chamber having a bottom and a plate is provided in a flow passage from the cyclone chamber to the dirt collection chamber and the bottom of the dirt collection chamber is pivotally mounted.

6. The surface cleaning apparatus as claimed in claim 5 wherein the plate is mounted to the bottom.

7. The surface cleaning apparatus as claimed in claim 4 wherein the first housing comprises a single cyclone.

8. The surface cleaning apparatus as claimed in claim 1 wherein the first and second housings have a volume and the surface cleaning apparatus has at least one cyclone and the at least one cyclone has a volume that is a least 40% of the volume of the first and second housings.

9. The surface cleaning apparatus as claimed in claim 8 the at least one cyclone has a volume that is a least 60% of the volume of the first and second housings.

10. The surface cleaning apparatus as claimed in claim 1 wherein the surface cleaning apparatus has at least one cyclone having a cyclone chamber and a cyclone chamber outlet and air travels from the cyclone chamber to the cyclone chamber outlet without passing through a porous member.

11. The surface cleaning apparatus as claimed in claim 1 wherein the second housing includes at least one removable mounted filter that is accessible when the lid is opened.

12. The surface cleaning apparatus as claimed in claim 11 wherein the at least one filter is provided in a filter housing and the filter housing is removable provided in the second housing and has handles.

13. A surface cleaning apparatus comprising:
(a) a fluid flow path extending from a dirty fluid inlet to a clean air outlet of the surface cleaning apparatus and including a suction motor
(b) at least first and second adjacent housings, each housing having an upper portion, the first housing includes a cyclone and the second housing includes the suction motor;
(c) at least one top panel provided on the upper portions, the top panel having an inner surface; and,
(d) an air flow passage from the first housing to the second housing forming part of the fluid flow path and defined as a volume between the inner surface of the top panel and the upper portions of the first and second housings.

14. The surface cleaning apparatus as claimed in claim 13 wherein a single top panel closes the upper portions.

15. The surface cleaning apparatus as claimed in claim 13 wherein the top panel comprises an openable lid.

16. The surface cleaning apparatus as claimed in claim 13 wherein the first housing comprises a single cyclone.

17. The surface cleaning apparatus as claimed in claim 13 wherein the first and second housings have a volume, the surface cleaning apparatus has at least one cyclone and the at least one cyclone has a volume that is a least 40% of the volume of the first and second housings.

18. The surface cleaning apparatus as claimed in claim 16 wherein the at least one cyclone has a volume that is a least 60% of the volume of the first and second housings.

19. The surface cleaning apparatus as claimed in claim 13 wherein the cyclone has a cyclone chamber and a cyclone chamber outlet and air travels from the cyclone chamber to the cyclone chamber outlet without passing through a porous member.

20. The surface cleaning apparatus as claimed in claim 15 wherein the second housing includes at least one filter that is visible when the lid is opened.

21. The surface cleaning apparatus as claimed in claim 20 wherein the at least one filter is mounted in a filter housing and the filter housing has handles.

22. The surface cleaning apparatus as claimed in claim 20 wherein the at least one filter is positioned above the suction motor.

23. A surface cleaning apparatus comprising:
(a) a fluid flow path extending from a dirty fluid inlet to a clean air outlet of the surface cleaning apparatus and including a suction motor;
(b) at least first and second adjacent housings, each housing having an upper portion, the first housing having at least one cyclone having a cyclone chamber and a cyclone chamber outlet, wherein air travels from the cyclone chamber to the cyclone chamber outlet without passing through a porous member;
(c) at least one top panel provided on the upper portions, the top panel having an inner surface; and,
(d) an air flow passage from the first housing to the second housing forming part of the fluid flow path and defined as a volume between the inner surface of the top panel and the upper portions of the first and second housings.

24. The surface cleaning apparatus as claimed in claim 23 wherein a single top panel closes the upper portions.

25. The surface cleaning apparatus as claimed in claim 23 wherein the top panel is openable.

26. The surface cleaning apparatus as claimed in claim 23 wherein the second housing includes the suction motor.

27. The surface cleaning apparatus as claimed in claim 23 wherein the first housing comprises a single cyclone.

28. The surface cleaning apparatus as claimed in claim 25 further comprising at least one filter that is visible when the top panel is opened.

29. The surface cleaning apparatus as claimed in claim 28 wherein a suction motor and fan assembly is positioned below the at least one filter.

30. A surface cleaning apparatus comprising:
(a) a fluid flow path extending from a dirty fluid inlet to a clean air outlet of the surface cleaning apparatus and including a suction motor;
(b) at least first and second adjacent housings, each housing having an upper portion;
(c) an air flow passage from the first housing to the second housing forming part of the fluid flow path and defined as a volume between the inner surface of the lid and the upper portions of the first and second housings; and,
(d) at least one filter that is visible when the top panel is opened.

31. The surface cleaning apparatus as claimed in claim 30 wherein at least one filter is removably mounted in the surface cleaning apparatus

32. The surface cleaning apparatus as claimed in claim 30 wherein the at least one filter is mounted in a filter housing and the filter housing has handles.

33. The surface cleaning apparatus as claimed in claim 32 wherein a single lid closes the upper portions.

34. The surface cleaning apparatus as claimed in claim 32 wherein the first housing includes a cyclone and the second housing includes the suction motor.
